(19) United States
(12) Patent Application Publication
(10) Pub. No.: US 2022/0350832 A1
(43) Pub. Date: Nov. 3, 2022

(54) Artificial Intelligence Assisted Transfer Tool

(71) Applicant: American Chemical Society, Washington, DC (US)

(72) Inventors: Yinghao Ma, Potomac, MD (US); Charley Trowbridge, Callicoon, NY (US); James Liu, Sterling, VA (US); Sonja Krane, Blue Bell, PA (US); Jofia Jose Prakash, Aldie, VA (US); Utpal Tejookaya, Springfield, VA (US); Jeroen Van Prooijen, Fairfax, VA (US); Jonathan Hansford, Burke, VA (US); Wallace Scott, Fairfax Station, VA (US); Jinglei Li, Falls Church, VA (US)

(73) Assignee: American Chemical Society, Washington, DC (US)

(21) Appl. No.: 17/733,157

(22) Filed: Apr. 29, 2022

Related U.S. Application Data
(60) Provisional application No. 63/181,487, filed on Apr. 29, 2021.

(51) Int. Cl. G06F 16/35; G06F 16/38; G06F 16/33

(52) U.S. Cl. CPC G06F 16/353; G06F 16/38; G06F 16/3347; G06Q 50/00

(57) ABSTRACT

A method is disclosed, involving converting each structured text document stored in a database into one or more vectors, training a machine learning model to associate structured text document vectors with the journals said structured text document were published in; receiving an additional structured text document, converting said additional structured text document into one or more vectors, and processing the additional structured text document through the trained machine learning model to identify an appropriate journal for publication. Systems and computer-readable media implementing the method are also disclosed.

### CROSS-REFERENCE TO RELATED APPLICATIONS

This application claims priority to provisional patent application No. 63/181,487, filed Apr. 29, 2021.

### BACKGROUND

### Field

Embodiments of the present disclosure relate to Artificial Intelligence Tools for identifying suitable alternative publications for structured text documents.

### Description of Related Art

Publishers of scientific or academic journals often operate multiple such publications covering a given field or discipline. Manuscripts submitted to a particular publication may be better suited to another publication run by the same publisher. However, the majority of rejected manuscripts are eventually published, but are less frequently published in journals belonging to the same publisher that initially rejected them. Furthermore, research authors receiving a reject-with-transfer decision are less dissatisfied than authors rejected without a transfer offer. Editors and reviewers for a given publication may lack the time or knowledge to identify an appropriate alternative publication for papers they reject from their publication, and existing publication management tools lack the capability to make targeted transfer recommendations. Therefore, there is a need for improved systems and methods for leveraging machine learning to improve publication management tools to identify and recommend alternative publications for rejected manuscripts to assist with placing manuscripts in appropriate publications.

### SUMMARY

One aspect of the present disclosure is directed to a method for identifying suitable alternative publications for structured text documents. The method comprises, for example, converting each structured text document stored in a database into one or more vectors, each structured text document having a title, an abstract, a full text, metadata, and journal of publication. The method further comprises, for example, training a machine learning model to associate structured text document vectors with the journals said structured text document were published in. The method further comprises, for example, receiving an additional structured text document, having a title, an abstract, a full text, and metadata. The method further comprises, for example, converting said additional structured text document into one or more vectors. Finally, the method further comprises processing the additional structured text document through the trained machine learning model to identify an appropriate journal for publication.

Yet another aspect of the present disclosure is directed to a system for identifying suitable alternative publications for structured text documents. The system comprises, for example, at least one processor, and at least one non-transitory computer readable media storing instructions configured to cause the processor, to for example, convert each structured text document stored in a database into one or more vectors, each structured text document having a title, an abstract, a full text, metadata, and journal of publication. The processor may also, for example, train a machine learning model to associate structured text document vectors with the journals said structured text document were published in. The processor may also, for example, receive an additional structured text document, having a title, an abstract, a full text, and metadata. The processor may also, for example, convert said second additional text document into one or more vectors. Finally, the processor may also, for example, process the second structured text document through the trained machine learning model to identify an appropriate journal for publication.

### BRIEF DESCRIPTION OF DRAWING(S)

FIG. 1 depicts a system for performing a method of training a machine learning model to recommend suitable alternative publications for structured text documents.

FIG. 2 depicts a system for performing a method for generating a list of high volume journals similar to low volume journals.

FIG. 3 depicts further embodiments of the system from FIG. 1.

### DETAILED DESCRIPTION

It is an object of the present disclosure to identify suitable alternative publications for structured text documents.

It should be understood that the disclosed embodiments are intended to be performed by a system or similar electronic device capable of manipulating, storing, and transmitting information or data represented as electronic signals as needed to perform the disclosed methods. The system may be a single computer, or several computers connected via the internet or other telecommunications means.

A method includes converting each structured text document stored in a database into one or more vectors, each structured text document having a title, an abstract, a full text, metadata, and journal of publication. A structured text document may be a draft, a manuscript, a book, an article, a thesis, a dissertation, a monograph, a report, a proceeding, a standard, a patent, a preprint, a grant, or other working text. An abstract may be a summary, synopsis, digest, precis, or other abridgment of the structured text document. An author may be any number of individuals or organizations. A structured text document may also have metadata, such as citations or the author's previous publication history. A journal of publication may be magazine, periodical, a review, a report, a newsletter, a blog, or other publication of academic or scientific scholarship. A person of ordinary skill in the art would understand that a structured text document could take many forms, such as a Word file, PDF, LaTeX, or even raw text.

The system may convert the structured text documents into vectors using a natural language processing algorithm with a vector output. In broad terms, suitable algorithms accept text as input and render a numerical representation of the input text, known as a vector, as output. Suitable natural language processing algorithms include examples such as Gensim Doc2Vec, GloVe/PCA projection, BERT, SciBERT, SPECTER, or Universal Sentence Encoder, though a person of ordinary skill in the art may recognize other possible natural language processing algorithms. The system may convert different parts of a structured text document into different types of vectors. For example, the full text may be converted using Doc2Vec, while the metadata may be converted into a one-hot vector using one-hot vector encoding. Other arrangements (including where some portions of the structured text document are not converted to vectors) are also possible in some embodiments. A vector, in some embodiments, can be a mathematical concept with magnitude and direction. In other embodiments, a vector can be a collection of values representing a word's meaning in relation to other words. In yet other embodiments, a vector can be a collection of values representing a text's value in relation to other texts.

Two example embodiments of a vector can be vector 1 with the values (A, B) and vector 2 with the values (C, D) where A, B, C, and D are variables representing any number. One possible measure of distance, the Euclidean distance, between vector 1 and vector 2 is equal to \sqrt{(C−A)²+(D−B)²}. Of course, one skilled in the art can recognize that vectors can have any number of values. One skilled in the art would also recognize measures of distance between vectors beyond the Euclidean distance, such as Manhattan distance or Cosine similarity

In some embodiments, the structured text document database may be implemented as a collection of training data, such as the Microsoft Academic Graph, or may be implemented using any desired collection of structured text documents such as a journal's archive or catalog. The database may be implemented through any suitable database management system such as Oracle, SQL Server, MySQL, PostgreSQL, Microsoft Access, Amazon RDS, HBase, Cassandra, MongoDB, Neo4J, Redis, Elasticsearch, Snowflake, BigQuery, or the like.

In some embodiments the system uses the vectors of the structured text documents, as well as the journals of publication associated with each structured text documents, to train a machine learning model to associate the vectors of structured text documents with their journals of publication. The machine-learning model may include, for example, Viterbi algorithms, Naïve Bayes algorithms, neural networks, etc. and/or joint dimensionality reduction techniques (e.g., cluster canonical correlation analysis, partial least squares, bilinear models, cross-modal factor analysis) configured to observe relationships between the vectors of structured text documents and the journals of publication. In some embodiments, training the machine learning model may be a multi-layer deep learning multi-class classifier. In some embodiments, a subset of the vectors of the structured text documents are used to train the machine learning model. For example, the model may be trained only on structured text documents published within the last five years.

In some embodiments, the system receives an additional structured text document. The additional structured text document may be received by various means, including electronic submission portal, email, a fax or scan of a physical copy converted into a structured text document through a process such as optical character recognition or similar means, or other means for digital transmission.

Once received by the system performing a disclosed embodiment, the system may convert the additional structured text document to one or more vectors. Conversion of the additional structured text document into a vector may be accomplished as previously described.

In some embodiments the system uses the vector of the additional structured text document as an input to the trained machine learning model. The machine learning model, based on its training and vector input, outputs an appropriate journal for publication. In some embodiments the machine learning model also outputs confidence scores for journals of publication. In some embodiments, confidence scores are numeric values that represent the machine learning model's prediction that a given journal is the best, or appropriate, journal for an additional structured text document. In some embodiments, confidence scores are softmax values, where the sum of all assigned confidence scores for an additional structured text documents must sum to 1.00. For example, given an additional structured text document, the machine learning model may calculate a confidence score for journal 1 of 0.85, a confidence score for journal 2 of 0.09, and a confidence score for journal 3 of 0.03. In this example, the machine learning model is 85% confident the additional structured text document should be assigned to journal 1.

In some embodiments, the system may include a second database of structured text documents, each with a title, an abstract, a full text, metadata, and journal of publication. The structured text documents in the second database are associated with a “low volume” or “new” journal of publication. In some embodiments, a “low volume” journal is defined as a journal that publishes fewer than a set number of articles per year (e.g., 200). In other embodiments, a “new” journal is defined as a journal that has been publishing for less than a certain number of years (e.g., two years). In some embodiments, journals that are not “low volume” are “high volume” journals. Journals that publish less than 200 articles a year, or that have been publishing for less than two years, may lack a sufficient volume of structured text documents to train the machine learning models to recognize appropriate additional structured text documents. The system updates which journals are in the first database (high volume) and which journals are in the second database (low volume) periodically. In some embodiments, the system may update which journals are in the first database and which journals are in the second database on a period basis, including, for example, daily.

The method may involve associating each low volume journal with a high volume journal. In some embodiments, structured text documents published in high and low volume journals are stored in separate databases—the structured text documents published in high volume journals in a first database, the structured text documents published in low volume journals in a second database. The system converts each structured text document stored in the first and second databases into one or more vectors, as previously described. Then, for each journal having documents in either database of structured text documents, the system calculates an average vector value for all structured text documents published in that journal. Then, the system uses the average vector values for each journal to calculate the distance between each the average vector values for each journal, using a suitable method such as Euclidean distance or cosine similarity, though one skilled in the art would also recognize measures of distance between vectors beyond these two measures. The system stores these values.

Cosine similarity is a measure of similarity between vectors that can be explained with reference to example vector A with the values (A₁, A₂ . . . Aₙ) and vector B with the values (B₁, B₂ . . . Bₙ). The cosine similarity between vectors A and B may be calculated as:

$$\frac{{\sum }_{i = 1}^{n} {A}_{i} {B}_{i}}{\sqrt{{\sum }_{i = 1}^{n} {( {A}_{i} )}^{2}} * \sqrt{{\sum }_{i = 1}^{n} {( {B}_{i} )}^{2}}}$$

The method may involve the system using the vectors of the additional structured text document as an input to the trained machine learning model. The machine learning model, based on its training and vector input, outputs an appropriate journal for publication, which will be from the first database. The system then also identifies the journal from the second database that has the closest similarity score to the appropriate journal from the first database.

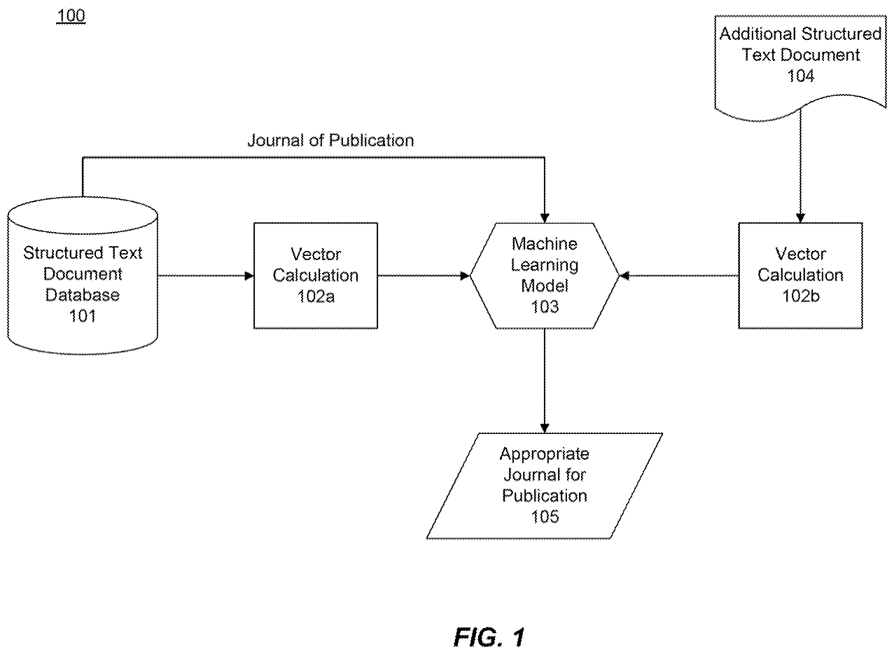

FIG. 1 shows a schematic block diagram 100 of a system for performing the disclosed exemplary embodiment of a method including computerized systems for identifying appropriate journals. In some embodiments, system 100 includes structured text document database 101, vector calculations 102a and 102b, machine learning model 103, additional structured text document 104, and appropriate journal for publication 105.

In some embodiments, system 100 should be understood as a computer system or similar electronic device capable of manipulating, storing, and transmitting information or data represented as electronic signals as needed to perform the disclosed methods. System 100 may be a single computer, or several computers connected via the internet or other telecommunications means.

A method includes converting each structured text document stored in a database 101 into one or more vectors, each structured text document having a title, an abstract, a full text, metadata, and journal of publication. A structured text document may be a draft, a manuscript, a book, an article, a thesis, a dissertation, a monograph, a report, a proceeding, a standard, a patent, a preprint, a grant, or other working text. An abstract may be a summary, synopsis, digest, precis, or other abridgment of the structured text document. An author may be any number of individuals or organizations. A structured text document may also have metadata, such as citations. A journal of publication may be magazine, periodical, a review, a report, a newsletter, a blog, or other publication of academic or scientific scholarship. A person of ordinary skill in the art would understand that a structured text document could take many forms, such as a Word file, PDF, LaTeX, or even raw text.

In some embodiments, vector calculations 102a and 102b may be implemented by system 100 using a natural language processing algorithm with a vector output. In some embodiments, vector calculations 102a and 102b are processes executed by program code stored on the medium operated by the processor. In broad terms, suitable algorithms accept text as input and render a numerical representation of the input text, known as a vector, as output. Suitable natural language processing algorithms include examples such as Gensim Doc2Vec, GloVe/PCA projection, BERT, SciBERT, SPECTER, or Universal Sentence Encoding, though a person of ordinary skill in the art may recognize other possible natural language processing algorithms. Vector calculations 102a and 102b may convert different parts of a structured text document into different types of vectors. For example, the full text may be converted using Doc2Vec, while the metadata may be converted into a one-hot vector using one-hot vector encoding. Other arrangements (including where some portions of the structured text document are not converted to vectors) are also possible in some embodiments. A vector, in some embodiments, can be a mathematical concept with magnitude and direction. In other embodiments, a vector can be a collection of values representing a word's meaning in relation to other words. In yet other embodiments, a vector can be a collection of values representing a text's value in relation to other texts.

In some embodiments, the structured text document database 101 may be implemented as a collection of training data, such as the Microsoft Academic Graph, or may be implemented using any desired collection of structured text documents such as a journal's archive or catalog. The database may be implemented through any suitable database management system such as Oracle, SQL Server, MySQL, PostgreSQL, Microsoft Access, Amazon RDS, HBase, Cassandra, MongoDB, Neo4J, Redis, Elasticsearch, Snowflake, BigQuery, or the like.

In some embodiments the system 100 uses the vectors of the structured text documents, as well as the journals of publication associated with each structured text documents, to train a machine learning model 103 to associate the vectors of structured text documents with their journals of publication. In some embodiments, the machine learning model 103 can be trained with vector representations of the title, abstract, or metadata of the structured text documents. In some embodiments, machine learning model 103 is a process or processes stored on the medium operated by the processor. The machine-learning model 103 may include, for example, Viterbi algorithms, Naïve Bayes algorithms, neural networks, etc. and/or joint dimensionality reduction techniques (e.g., cluster canonical correlation analysis, partial least squares, bilinear models, cross-modal factor analysis) configured to observe relationships between the vectors of structured text documents and the journals of publication. In some embodiments, the machine learning model 103 may be a multi-layer deep learning multi-class classifier. In some embodiments, the machine learning model can be retrained periodically with new vectors of structured text document, and journals of publication. In some embodiments, this retraining may occur every two weeks. The retraining may entirely replace the training of the machine learning model, or it may supplement the existing training of the machine learning model 103. In some embodiments, a subset of the vectors of the structured text documents are used to train the machine learning model. For example, the model may be trained only on structured text documents published within the last five years.

A method may involve the system receiving an additional structured text document 104. The additional structured text document 104 may be received by various means, including electronic submission portal, email, a fax or scan of a physical copy converted into a structured text document through a process such as optical character recognition or similar means, or other means for digital transmission.

Once the additional structured text document 104 is received by the system 100, the system 100 may convert the additional structured text document 104 to a vector using vector conversion 102b. Conversion of the additional structured text document into a vector may be accomplished as previously described for vector conversion 102a.

The method may involve the system 100 using the vector of the additional structured text document 104 as an input to the trained machine learning model 103. In some embodiments, the machine learning model, based on its training and vector input, outputs an appropriate journal for publication 105. In some embodiments the machine learning model 103 also outputs confidence scores for journals of publication. In some embodiments, confidence scores are numeric values that represent the machine learning model's prediction that a given journal is the best, or appropriate, journal for an additional structured text document 104.

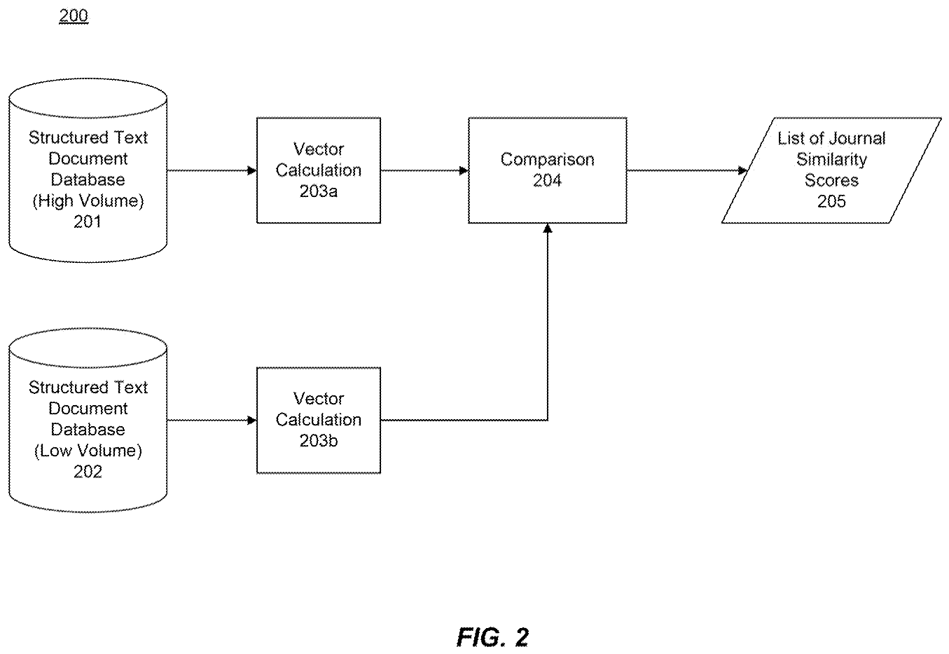

FIG. 2 shows a schematic block diagram 200 of a system for performing the disclosed exemplary embodiment of a method including computerized systems for calculating journal similarity scores. In some embodiments, system 200 includes structured text document database 201 containing structured text document from high volume journals (more than 200 articles a year), structured text document database 202 containing structured text document from low volume (200 or fewer articles a year) or new journals (oldest article less than two years old), vector calculations 203a and 203b, comparison 204, and list of journal similarity scores 205.

In some embodiments, vector calculations 203a and 203b may be implemented by system 200 using a natural language processing algorithm with a vector output. In some embodiments, vector calculations 102a and 102b are processes stored on the medium operated by the processor. In broad terms, suitable algorithms accept text as input and render a numerical representation of the input text, known as a vector, as output. Suitable natural language processing algorithms include examples such as Gensim Doc2Vec, GloVe/PCA projection, BERT, SciBERT, SPECTER, or Universal Sentence Encoder, though a person of ordinary skill in the art may recognize other possible natural language processing algorithms. Vector calculations 203a and 203b may convert different parts of a structured text document into different types of vectors. For example, the full text may be converted using Doc2Vec, while the metadata may be converted into a one-hot vector using one-hot vector encoding. Other arrangements (including where some portions of the structured text document are not converted to vectors) are also possible in some embodiments. A vector, in some embodiments, can be a mathematical concept with magnitude and direction. In other embodiments, a vector can be a collection of values representing a word's meaning in relation to other words. In yet other embodiments, a vector can be a collection of values representing a text's value in relation to other texts.

In some embodiments, the structured text document databases 201 and 202 may be implemented as a collection of training data, such as the Microsoft Academic Graph, or may be implemented using any desired collection of structured text documents such as a journal's archive or catalog. The database may be implemented through any suitable database management system such as Oracle, SQL Server, MySQL, PostgreSQL, Microsoft Access, Amazon RDS, HBase, Cassandra, MongoDB, Neo4J, Redis, Elasticsearch, Snowflake, BigQuery, or the like.

In some embodiments the system 200 performs comparison 204. In some embodiments, comparison 204 is a process or processes stored on the medium operated by the processor. In some embodiments, comparison 204 entails the system 200 calculating an average vector value for all structured text documents published in each journal with structured text documents published in the structured text document databases 201 and 202. In some embodiments, comparison 204 further entails the system using the average vector values for each journal to calculate the distance between each the average vector values for each journal, using a suitable method such as Euclidean distance or cosine similarity, though one skilled in the art would also recognize measures of distance between vectors beyond these two measures. In some embodiments, comparison 204 further entails the system 200 using the calculated distances between each high volume journal (i.e., those with structured text documents stored in database 201) and each low volume journal (i.e., those with structured text documents stored in database 202) to determine which low volume journal has the highest similarity score (or lowest distance) to each high volume journal.

In some embodiments the system 200 compiles the results of comparison 204 into the list of journal similarity scores 205. In some embodiments, the list of journal similarity scores is an index of high volume journals, each high volume journal having an associated low volume journal, the associated low volume journal being the journal with the highest similarity score (or lowest distance) to each high volume journal.

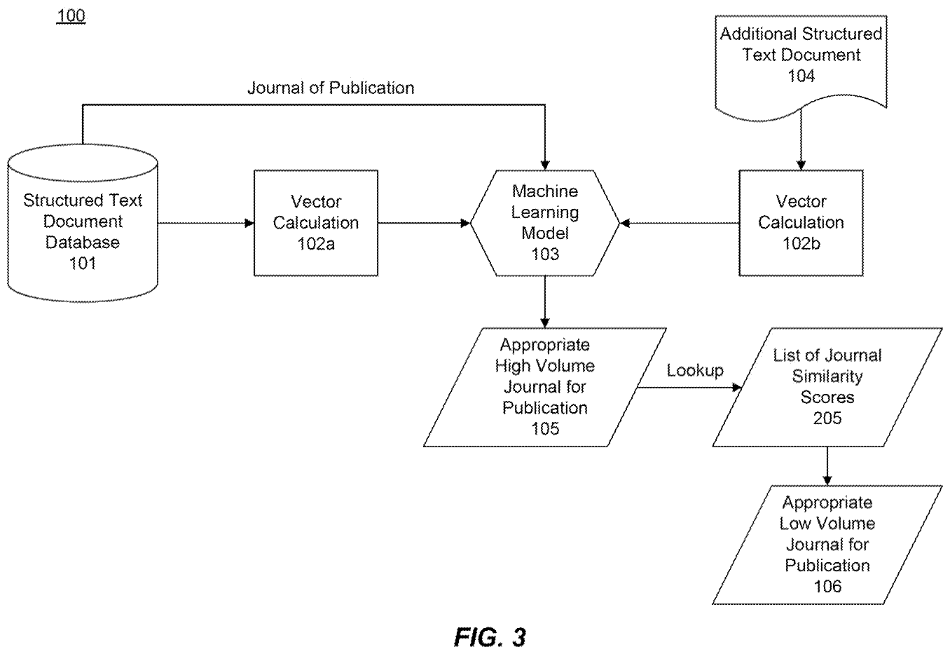

Referring now to FIG. 3, further embodiments of system 100 are shown for performing the disclosed exemplary embodiment of a method including computerized systems for identifying appropriate journals. In some embodiments, system 100 includes structured text document database 101, vector calculations 102a, and 102b, machine learning model 103, additional structured text document 104, and appropriate high volume journal for publication 105, appropriate low volume journal for publication 106, and list of journal similarity scores 205.

The structured text document database 101, vector calculations 102a and 102b, machine learning model 103, and additional structured text document 104 should be understood to have the same scope and functionality as disclosed in FIG. 1. The list of journal similarity scores 205 should be understood to have the same scope and functionality as disclosed in FIG. 2.

In the disclosed embodiments consistent with FIG. 3, the system 100 inputs the vector of the structured text document 104 into the machine learning model 103 trained using the vectors of the structured text documents in the structured text document database 101. In some embodiments, the machine learning model 103 then outputs a recommendation for an appropriate high volume journal for publication 105. Then, the system 100 queries the list of journal similarity scores 205 to retrieve the low volume journal 106 associated with high volume journal 105. In this way, the system 100 can recommend a suitable high volume journal and suitable low volume journal for additional structured text document 104.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

While illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Python, Java, C/C++, Objective-C, Swift, HTML, HTML/AJAX combinations, XML, or HTML with included Java applets.

What is claimed is:

1. A method for identifying appropriate journals for publication for structured text documents, comprising:
converting each structured text document stored in a database into one or more vectors, each structured text document having a title, an abstract, a full text, metadata, and a journal of publication;
training a machine learning model to associate structured text document vectors with the journals each structured text document was published in;
receiving an additional structured text document, having a title, an abstract, a full text, and metadata;
converting said additional structured text document into one or more vectors; and
processing the additional structured text document through the trained machine learning model to identify an appropriate journal for publication.

2. The method of claim 1 wherein:
the vectors of structured text documents published within the last five years are used to train the machine learning model.

3. The method of claim 1 wherein:
each structured text document stored in a database is converted into one or more vectors using Gensim Doc2Vec embedding; and
converting said additional structured text document into one or more vectors using Gensim Doc2Vec embedding.

4. The method of claim 1 wherein:
each structured text document stored in a database is converted into one or more vectors using one-hot vector encoding; and
converting said additional structured text document into one or more vectors using one-hot vector encoding.

5. The method of claim 1 wherein:
each structured text document stored in a database is converted into one or more vectors, using both Gensim Doc2Vec embedding and one-hot vector encoding; and
converting said additional structured text document into one or more vectors using both Gensim Doc2Vec embedding and one-hot vector encoding.

6. The method of claim 1 wherein:
the machine learning model is a multi-layer deep learning multi-class classifier.

7. The method of claim 1 wherein:
the journals of publication for each structured text documents stored in a database are all journals that publish at least 200 articles a year.

8. The method of claim 1 wherein:
the journals of publication for each structured text documents stored in a database are all journals have a first published article at least two years old.

9. The method of claim 1 wherein:
the journals of publication for each structured text documents stored in a database are all journals are at least two years old, and publish at least 200 articles a year.

10. The method of claim 9 further comprising:
converting each structured text document stored in a second database into one or more vectors, each structured text document having a title, an abstract, a full text, metadata, and journal of publication;
use the vectors of the structured text documents stored in the first database and the vectors of the structured text documents stored in the second database to compute the similarity score between each journal of publication; and
use the similarity score to recommend a journal from the second database alongside a journal from the first database when the machine learning algorithm recommends a journal from the first database.

11. A system for identifying appropriate journals for publication for structured text documents, comprising:
at least one processor, and
at least one non-transitory computer readable media storing instructions configured to cause the processor to:
convert each structured text document stored in a database into one or more vectors, each structured text document having a title, an abstract, a full text, metadata, and journal of publication;
train a machine learning model to associate structured text document vectors with the journals each structured text document was published in;
receive an additional structured text document, having a title, an abstract, a full text, and metadata;
convert said additional structured text document into one or more vectors; and
process the additional text document through the trained machine learning model to identify an appropriate journal for publication.

12. The system of claim 11 wherein:
the vectors of structured text documents published within the last five years are used to train the machine learning model.

13. The system of claim 11 wherein:
each structured text document stored in a database is converted into one or more vectors using Gensim Doc2Vec embedding; and
converting said additional structured text document into one or more vectors using Gensim Doc2Vec embedding.

14. The system of claim 11 wherein:
each structured text document stored in a database is converted into one or more vectors using one-hot vector encoding; and
converting said additional structured text document into one or more vectors using one-hot vector encoding.

15. The system of claim 11 wherein:
each structured text document stored in a database is converted into one or more vectors, using both Gensim Doc2Vec embedding and one-hot vector encoding; and
converting said additional structured text document into one or more vectors using both Gensim Doc2Vec embedding and one-hot vector encoding.

16. The system of claim 11 wherein:
the machine learning model is a multi-layer deep learning multi-class classifier.

17. The system of claim 11 wherein:
the journals of publication for each structured text documents stored in a database are all journals that publish at least 200 articles a year.

18. The system of claim 11 wherein:
the journals of publication for each structured text documents stored in a database are all journals have a first published article at least two years old.

19. The system of claim 11 wherein:
the journals of publication for each structured text documents stored in a database are all journals have a first published article at least two years old, and publish at least 200 articles a year.

20. The system of claim 19 wherein the instructions are further configured to cause the processor to:
convert each structured text document stored in a second database into one or more vectors, each structured text document having a title, an abstract, a full text, metadata, and journal of publication;
use the vectors of the structured text documents stored in the first database and the vectors of the structured text documents stored in the second database to compute the similarity score between each journal of publication; and
use the similarity score to recommend a journal from the second database alongside a journal from the first database when the machine learning algorithm recommends a journal from the first database.
